(19) United States
(12) Patent Application Publication
(10) Pub. No.: US 2009/0014296 A1
(43) Pub. Date: Jan. 15, 2009

(54) Contact configurations for MEMS relays and MEMS switches and method for making same

(75) Inventors: Alexis Christian Weber, Cambridge, MA (US); Alexander H. Slocum, Bow, NH (US); Jeffrey Lang, Sudbury, MA (US); Sami Kotilainen, Niederrohrdorf (CH); Jian Li, Fremont, CA (US)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 12/153,979

(22) Filed: May 28, 2008

Related U.S. Application Data
(63) Continuation of application No. PCT/CH2005/000703, filed on Nov. 28, 2005.

(51) Int. Cl. H01H 57/00; H01H 1/06; H01H 11/04

(52) U.S. Cl. 200/181; 200/502; 29/622

(57) ABSTRACT

Micro-electromechanical (MEMS) contact configuration is disclosed, comprising a static contact with at least one contact surface and a movable contact with at least one corresponding contact surface. Particularly flat contact surfaces and correspondingly low contact resistance can be achieved, if at least one contact surface plane is formed by a crystal plane of the wafer. Furthermore a method for manufacturing such a contact configuration is proposed, wherein the contact surfaces are obtained by wet anisotropic etching of a silicon wafer, if need be preceded by appropriate masking to expose the to be edged regions only, if need be followed by coating with an electrically conductive layer, e.g., a metal layer.

### RELATED APPLICATION

This application claims priority as a continuation application under 35 U.S.C. §120 to PCT/CH2005/000703 filed as an International Application on 28 Nov. 2005 designating the U.S., the entire content of which is hereby incorporated by reference in its entirety.

### TECHNICAL FIELD

The disclosure pertains to a micro-electromechanical (MEMS) contact configuration comprising a static contact with at least one contact surface and a movable contact with at least one corresponding contact surface, wherein at least one contact surface plane is formed by a crystal plane of the wafer. It furthermore pertains to a method for the manufacturing of such a contact configuration.

### BACKGROUND INFORMATION

Relays are devices used to switch circuits on and off. The switching function is achieved through a mechanism, which allows one or more contact-pads to be displaced between two discrete positions: a non-contact position (the relay is said to be in an “open circuit” state) and a contact position (the relay is said to be in a “closed circuit” state). When the relay contact pads are in physical contact with each other (contact position) the circuit is switched on. When the relay contact pads are in their non-contact position the current flow to the circuit is interrupted and the circuit is switched off.

It is desirable for the relay to have very low (ideally zero) contact resistance when the relay is in its closed circuit state.

The most common uses of relays are to control a high voltage circuit with a low voltage signal, to control a high electrical current circuit with a low electrical current and to isolate the controlling circuit from the controlled circuit.

Microelectromechanical switches (MEMS switches) and Microelectromechanical relays (MEMS relays) are known miniaturised devices. There are numerous commercially available MEMS relays and MEMS switches. An even greater number of research type MEMS relays and MEMS switches have been reported in the literature. Based on their design, MEMS relays and MEMS switches can be grouped into two categories: bulk micromachined and surface micromachined devices.

Bulk micromachined MEMS relays and MEMS switches have contacts normal to the wafer surface and their contact motion is parallel to the wafer surface. FIG. 1 shows a bulk micromachined MEMS relay 1 in its normally open (a) and normally closed (b) states. There is provided a static contact 3 which is fixed on a support structure 4. On the other hand there is provided a movable contact 2. In the contact region these contacts are coated with a conductive film 5, for example based on Au. Upon parallel motion (arrow 6) the contact moves from the open position (a) to the closed (b) position in which contact is established and current is allowed to flow.

Surface micromachined MEMS relays and MEMS switches have contacts parallel to the wafer surface and their contact motion is normal to the wafer surface. FIG. 2 shows such a surface micromachined MEMS relay 10 in its open circuit (a) and closed circuit (b) states. Also here there is a moving contact 7, in this case given as a compliant cantilever beam, and a static contact 8, both provided with an electrically conductive coating 5 in the region where contact shall be established. In this case however, for the closure of the switch a motion orthogonal to the plane of the wafer (arrow 9) is initiated.

One of the main functional requirements of MEMS relays and MEMS switches is to minimize the contact resistance (also known as closed-circuit resistance). Because of the configuration, small size scale and relatively low actuation forces present in MEMS relays and MEMS switches it is difficult to achieve very low contact-resistance values. Commercial application MEMS switches typically have contact resistance values in the order of 0.5 to 1 Ohms at best.

A thin highly conductive film (i.e. gold) is deposited on the electrodes of MEMS relays and MEMS switches to make them electrically conductive and minimize contact resistance when the device is in its closed-circuit state. In the above described prior art configurations, particularly in the case of bulk micromachined (in-plane contact motion) devices, it is difficult to obtain good step-coverage or conformality through metal evaporation or sputtering, which correspondingly gives rise to high contact resistance values. The term “step coverage” refers to the thickness uniformity of the metal film deposited over sharp corners/edges such as between the electrode and the wafer surface in bulk micromachined devices.

FIGS. 3a, 3b, 3c show the metallization process 11, which is carried out from both sides sequentially or concomitantly, of a bulk micromachined MEMS relay, with the resultant poor step coverage indicated in the highlighted region A, where the poor step coverage 12 with different coating thicknesses along different planes can be recognised.

It is known that perfect vertical and planar walls cannot be obtained through dry etching processes. The resultant contacts of bulk micromachined devices are generally slightly tapered and non planar. When these non-flat non-parallel faces come into contact as the relay is in its closed circuit state, the overall contact area is reduced leading to high values of contact resistance. FIG. 4a shows an exaggerated view of a bulk micromachined MEMS relays with non-flat non-parallel contacts 13 and the resulting reduced contact area 14 when the device is in its closed (b) circuit mode.

The effect of poor step coverage and non-flat non-parallel electrodes is high contact resistance. Very good step coverage can be achieved through electroplating, however as electroplating is not a standard CMOS process, it is difficult to implement in a conventional MEMS foundry and significantly constrains the design options due to compatibility problems of the processes and the process contamination. As described previously, good step coverage is not enough to ensure low contact resistance due to the reduced contact area caused by the contacts not being planar and parallel.

### SUMMARY

Exemplary embodiments disclosed herein can provide an improved micro-electromechanical contact configuration for contacting at least one movable contact with at least one static contact (wherein it is however in principle also possible that both contacts are movable), by means of corresponding contact surfaces.

A micro-electromechanical contact configuration is disclosed comprising a static contact with at least one contact surface and a movable contact with at least one corresponding contact surface, wherein at least one contact surface plane is formed by a crystal plane of the wafer, wherein this crystal plane of the wafer is used as one of the contact surfaces.

A method for manufacturing said contact configuration is disclosed, wherein the contact surfaces are obtained by wet anisotropic etching of a silicon wafer, if need be preceded by appropriate masking to expose the to-be-edged regions only, if need be followed by coating with an electrically conductive layer.

### BRIEF DESCRIPTION OF THE DRAWINGS

In the accompanying drawings exemplary embodiments of the disclosure are shown in which:

FIG. 1 shows a bulk micro-machined MEMS relay according to the state of the art shown in its open circuit (a) and in its closed-circuit state (b);

FIG. 2 shows a surface micro-machined MEMS relay according to the state of the art shown in its open circuit (a) and in its closed-circuit state (b);

FIG. 3 shows a prior art metallization process (a) and the resulting poor step coverage (b and c);

FIG. 4 shows a prior art MEMS relay contact configuration as produced by using dry etching in open state (a) and closed-circuit state (b)

FIG. 5 shows a V-groove of (100) silicon (a) and a trench groove of (110) silicon (b) as obtained through wet anisotropic etching;

FIG. 6 shows oblique parallel contact surfaces as obtained through concomitant anisotropic wet etching from both sides of the wafer;

FIG. 7 shows the metallization step of the oblique structures and the corresponding step coverage;

FIG. 8 shows the contact behaviour of a relay according to a first embodiment in its open circuit (a) and its closed circuit state (b);

FIG. 9 shows the contact behaviour of a multiple-state relay according to a second embodiment in its open circuit (a), in its first closed-circuit (b) and in its second closed-circuit (c) state;

FIG. 10 shows the contact behaviour of a multiple-state relay according to a third embodiment in its open circuit (a), in its first closed-circuit (b) and in its second closed-circuit (c) state;

FIG. 11 shows the contact behaviour of a multiple-state relay according to a fourth embodiment analogous to FIG. 10;

FIG. 12 shows a truncated pyramid contact element (a), a V-groove contact element (b), a truncated pyramid contact element interdigitating with a V-groove contact element (c), the system according to (c) in closed-circuit state by out of plane motion of one of the contact elements (d), the system according to (c) in closed-circuit state by in plane motion of one of the contact elements (e);

FIG. 13 shows a more detailed example of an MEMS relay structure using oblique contact surfaces according to the present disclosure; and

FIG. 14 shows the individual processing steps to arrive at a contact surface configuration according to the present disclosure.

### DETAILED DESCRIPTION

One of the key features of the disclosure is therefore the fact that it has been recognised that the exposition of a crystal plane of the wafer, which most simply is possible to manufacture by wet anisotropic etching techniques, leads to surprisingly flat surfaces, which form an ideal basis for contact surfaces. It must be understood that usually the exposition of such crystal planes is undesired and many proposals have been made to avoid them when using wet anisotropic etching techniques. However, it has been found that these crystal planes are actually ideal as contact surfaces. The contact surfaces provided are therefore completely flat even on a molecular level. This is useful for bulk as well as surface micro-machined devices.

In a first exemplary embodiment of the present disclosure, both contacts, i.e. the movable or flexible contact and the static contact, are formed from an identical wafer crystal orientation (e.g. both (100)), and corresponding contact surfaces, i.e. contact surfaces which upon the establishment of the contact are touching each other, are formed by the same crystal plane of the wafers. Due to the identical crystal orientation of the wafer and due to the inherently parallel crystal surfaces, not only exceptionally flat contact surfaces can be generated, but due to the parallel orientation of corresponding crystal planes also the two contact surfaces to be contacted are perfectly aligned in parallel. The most simple realisation is, as preferred, if both contacts, or several contacts for multistate switches, are formed from the same wafer.

A further exemplary embodiment of the present disclosure is characterised in that the wafer has an upper surface and an undersurface which are parallel to each other, and in that the contact surfaces are inclined with respect to said surfaces. The provision of inclined contact surfaces allows to largely avoid the above-mentioned problems with poor step coverage, as coating with an electrically conductive film is much easier if inclined contact surfaces are used. Specifically, such inclined contact surfaces are inclined with respect to the surface of the wafer by angles in the range of 4°-110°, preferably 54.7°. The easiest realisation of such angled contact surfaces is possible, if the wafer is a (100) silicon wafer and if the contact surfaces are given by planes along specific crystal planes such as (111). If the ingot is cut obliquely at an angle α to (100) the (111) will be at an angle 54.7°±/−α to the wafer surface. For practical purposes α<50° (in this respect see also: Werkmeister J., “Development of Silicon Insert Molded Plastic”, Engineer's thesis MIT, 2005, page 12). A commonly used orientation-dependent etch for silicon to produce such structures consists of a mixture of potassium hydroxide (KOH) in water and isopropyl alcohol. In general this is referred to as KOH etch. The ratio of the etch rates for the (100) and (110) planes to the (111) plane are very high, typically 400:1 and 600:1, respectively. Therefore the (111) crystal plane is given as contact surface, as it is fabricated by the KOH etch. Further improvements and simplifications are possible if each contact, i.e. the static and the movable contact, is provided with a pair of contact surfaces which are tilted with respect to each other. Thus pointed contacts are generated, wherein parallel opposing surfaces are establishing a contact. The two pairs of contact surfaces are preferentially obtainable or obtained by means of etching (e.g. wet etching or by means of another technique exposing specific crystal surfaces for example due to different etching speed along different crystal planes) of a V-groove from the upper surface and a parallel V-groove from the undersurface, wherein the two V-grooves are laterally offset from each other, thereby preferably leading to a long contact surface and to a short contact surface on each contact.

It is alternatively possible to have two pairs of contact surfaces that are given as the two flanks of a V-groove on one contact and are given as the two flanks of a corresponding V-rib, truncated V-rib, pyramid or truncated pyramid-structure on the other contact. In this specific situation one has the advantage that not only motion parallel to the plane of the wafer is possible for establishing a contact, but also motion orthogonal to the plane of the wafer is possible, if the two contacts are arranged in an interdigitating manner.

According to another exemplary embodiment of the contact configuration according to the present disclosure the wafer has an upper surface and an undersurface which are parallel to each other, and for establishing a contact between the contact surfaces the movable contact moves parallel to said surfaces (i.e. bulk micro-machined device) or substantially orthogonal (i.e. e.g. surface micro-machined device) to said surfaces.

The proposed structure can be used for a two-state switch. It can, however, also advantageously be used in the context of multistate switches, so according to another exemplary embodiment, there is provided a multiple switching state switch with at least two opposing static contacts preferentially each provided with a pair of contact surfaces which are inclined with respect to each other and each with respect to an upper surface and undersurface of the wafer, and there is provided at least one movable contact located (in plane) between said two opposing static contacts preferentially provided with two pairs of contact surfaces which two pairs are located opposite to each other and which contact surfaces are inclined with respect to each other and each with respect to an upper surface and an undersurface of the wafer. Preferably, the pairs of contact surfaces provided on the at least two opposing static contacts are arranged in a mirror symmetric manner, i.e. mirror symmetric with respect to a central plane orthogonal to the surface of the wafer and parallel to the edges formed by the contact surfaces. Preferably, also the pairs of contact surfaces on the movable contact are mirror symmetric with respect to a central plane orthogonal to the surface of the wafer and parallel to the edges formed by the contact surfaces.

A further exemplary embodiment of the contact configuration is characterised in that all the contacts are formed from the same wafer, wherein the movable contact moves substantially parallel to the upper surface for either establishing a contact between the first static contact and the movable contact or establishing a contact between the second static contact and the movable contact.

It is for example possible to provide a stack of at least two wafers with the same crystal orientation, preferentially of three wafers, wherein the movable contact moves at least partially orthogonal, preferably substantially orthogonal to the upper surface for either establishing a contact between a first static contact and the movable contact or establishing a contact between the second static contact and the movable contact, and wherein at least one, preferentially all of the static contacts are formed from a different wafer as the one out of which the movable contact is made. It is to be noted that also combined motions parallel and orthogonal to the surface are possible depending on the needs and the mobility of the corresponding cantilever.

The movable contact can be formed from a middle wafer which is located between an upper wafer out of which one static contact is formed, and a lower wafer out of which the other static contact is formed. In this case, it is possible to use the middle wafer with full width. It is, however, also possible to provide a middle wafer, which in the region not contributing to the movable contact is reduced in thickness compared to the movable contact. This can be used to adjust the travelling pathway from the (usually open circuit) equilibrium position of the movable contact to the contacting position according to specific needs. It is for example possible to provide a very short travelling pathway to one of the static contacts, and a long travelling pathway to the other of the static contacts. Preferentially, it is also possible to provide static contacts which are contacting the movable contact over a plurality of contact surfaces, such that there are, e.g., two pairs of contacting surfaces in the closed state.

The contact surfaces are preferably coated with an electrically conductive coating or film, preferentially based on Ag, Au, Cu or another electrically conductive metal. Furthermore, the contacts are preferably formed from at least one, preferentially double side polished (DSP) silicon wafer with a thickness in the range of 150-1000 μm, preferentially of 300-700 μm.

The present disclosure further pertains to a method for manufacturing a contact configuration as described above. In this method the contact surfaces are obtained by wet anisotropic etching of a silicon wafer, if need be preceded by appropriate masking to expose the to-be-etched regions only, if need be followed by coating with an electrically conductive layer, preferentially a metal layer. Preferably, as an anisotropic etchant an aqueous hydroxide solution e.g. of alkali or earth alkali metals, preferably selected from NaOH, KOH, LiOH or mixtures thereof, or tetramethylammonium hydroxide (TmAH) or ethylene-diamine-pyrokatechol (EDP) are used in a concentration and under conditions such that slower etching crystal planes are selectively exposed.

Preferentially, a (100) silicon wafer is etched from both sides such that two opposite and parallel V-grooves are forming which are offset with respect to each other, wherein the process leads to through-etching, thus separating e.g. a future static contact from a future movable contact.

The present disclosure addresses two main problems with prior art MEMS relays and MEMS switches which lead to large contact resistance: poor step coverage and reduced contact area due to non-planar non-parallel contacts.

In the absence of large actuation forces two attributes are required to ensure low contact resistance in relays and switches: adequate contact geometry and adequate contact metallization (good step coverage). Good contact parallelism and contact smoothness (flatness) increases the physical contact area, thus reducing the contact resistance of the “closed-circuit” relay. Contact parallelism and smoothness are particularly important in the case of MEMS relays and MEMS switches since the actuation forces are relatively small due to the size scaling and the inherent physics of MEMS actuators. Adequate metallization of the electrodes is also necessary but is often difficult to achieve due to restricted access to the contact pads.

The present disclosure thus describes the use of highly planar (smooth) and highly parallel surfaces as contact surfaces. The proposed contacts result in lower contact resistance than the one in prior art devices because of their tight geometrical tolerances and increased step coverage capabilities. These surfaces are e.g. created by selective (anisotropic) etching of the silicon of a wafer. Fast etching crystalline planes thereby expose the slower etching crystalline planes. The resulting surfaces are extremely smooth and extremely parallel due to the molecular or atomic structure defined in the crystal. Furthermore, these surfaces can be etched with an oblique orientation to the wafer surface which increases the exposed area and thereby greatly simplifies the metallization step particularly in bulk micromachined MEMS relays and MEMS switches, which allows to avoid the problems of poor edge coverage.

Wet anisotropic etching of silicon is in principle known in the MEMS field. The possible anisotropic etchants are aqueous hydroxide solutions of alkali metals (e.g., NaOH, KOH, etc.), tetramethylammonium hydroxide (TmAH) and ethylene-diamine-pyrocatechol (EDP). The etch rate of these bases is highly dependant on the crystalline orientation of the silicon, such that the slower etching planes are exposed as the silicon is etched.

FIG. 5 shows a “V-groove” 17 and a trench 18, both common geometries obtained through anisotropic etching of (100) silicon and (110) silicon wafers, respectively.

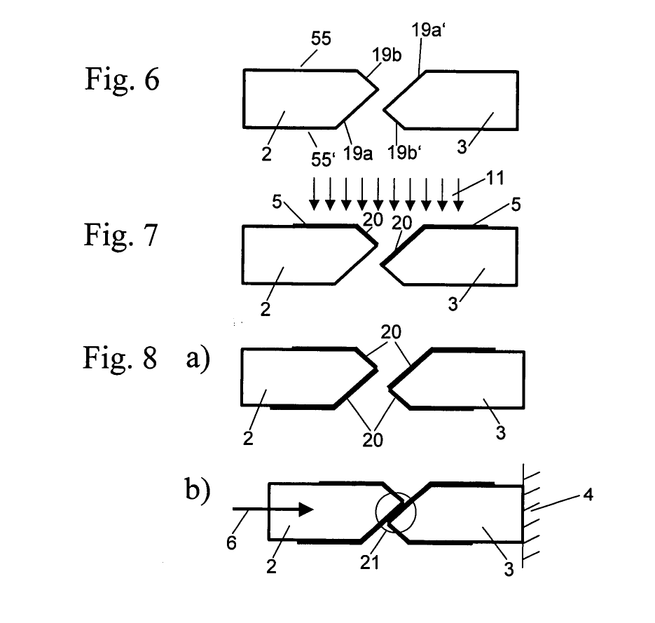

Wet anisotropic etching of (100) silicon from both sides of the wafer while having an offset between the front and back side of the masks yields the oblique structures which are one of the main aspects of the present disclosure, shown in FIG. 6. In this case, contact surfaces 19 are provided, wherein those contact surfaces are given by two long contact surfaces 19a and 19a′ and two short contact surfaces 19b and 19b′. In this case there is a rotational 180° symmetry around a central axis which automatically arises due to the anisotropic etching of two equal V-grooves from the two sides of the wafer. This anisotropic etching may either be carried out sequentially from the two sides 55, 55′, or may preferentially be carried out simultaneously on both sides.

It is known that the exposed surfaces formed by slower etching plane surfaces are inherently extremely smooth. Furthermore, because of the crystalline etch dependency extremely parallel surfaces can be achieved due to the crystal structure, which is identical in the two parts 2 and 3. The oblique geometry of this structure allows for better step coverage during the metallization process 11 than that of prior art bulk micromachined relays. This is because of the increased projection area in the main direction of deposition. FIG. 7 shows the metallization step 11 of the oblique structures and the resultant improved or enhanced step coverage.

The extremely parallel and extremely flat contact surfaces 19 of the disclosure result in an increased contact area and thus reduced contact resistance.

FIG. 8 shows an embodiment of the disclosure in which the contact motion is parallel to the wafer, wherein the open circuit situation is shown in (a) and the closed circuit situation is shown in (b).

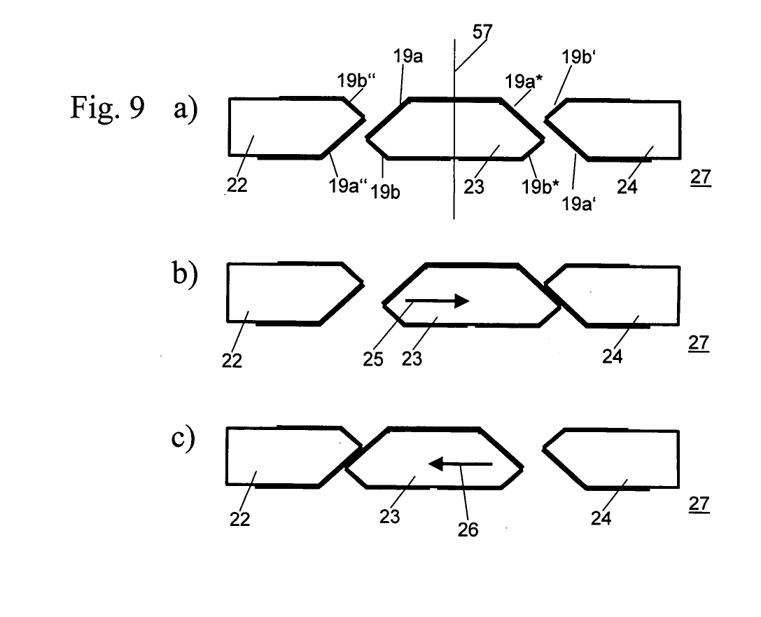

A symmetric arrangement of the previous embodiment as shown in FIG. 8 can be used as a change-over relay with either two or three discrete states as displayed in FIG. 9: a) contacts 22, 23 and 24 open circuit (o.c.), b) contacts 23 and 24 closed circuit (c.c.) and contacts 22 and 23 o.c., c) contacts 22 and 23 c.c. and contacts 23 and 24 o.c. In this case the contact movement of the element 23 (the flexure) is parallel to the wafer plane.

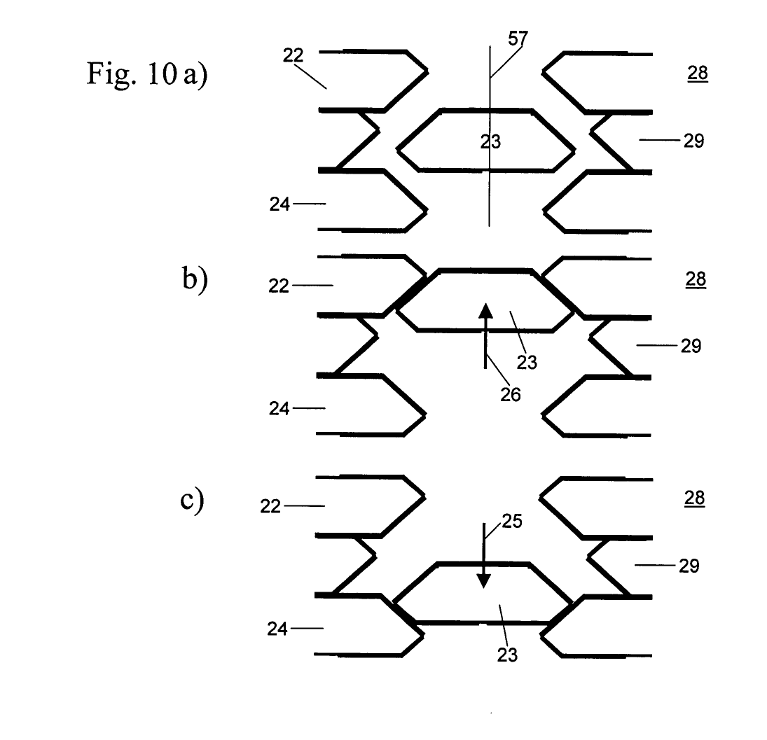

Vertical arrangement of three wafers using the embodiment shown in FIGS. 8 and 9 can be used for out of plane contact motion as shown in FIG. 10. Notice that FIG. 10 only shows the embodiment based an FIG. 9. A similar embodiment based on FIG. 8 with three layers is also implied. It is furthermore noted that also combined motion parallel and orthogonal to the plane of the wafers is possible. In FIG. 10 correspondingly an embodiment of the disclosure as change over relay with contact movement orthogonal to the wafer plane is shown, wherein a) 22, 23, 24 o.c., b) 22, 23 c.c., 23, 24 o.c., c) 22, 23 o.c, 23, 24 c.c.

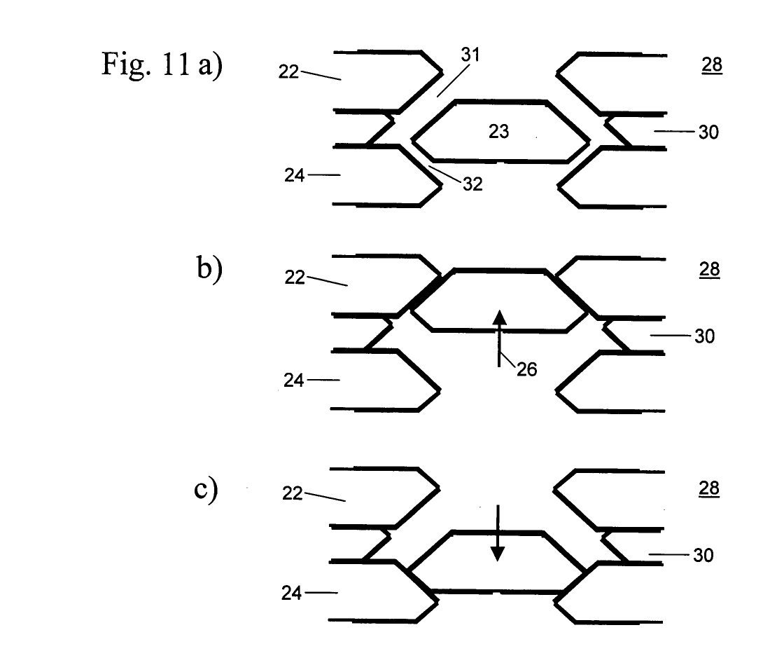

The contact travel in an embodiment as shown in FIG. 10 can be modified specifically either in both directions 25, 26 equally or selectively along one direction by thinning one or both sides of the centre wafer 29, specifically the portion which does not constitute the contact. Thus different travel lengths can be obtained between contacts 22 and 23 and 23 and 24. Such an embodiment is shown in FIG. 11, in which there is provided a thinned centre wafer 30. Also a normally closed device can be created through adequate thinning of the wafers (not shown in the Figures).

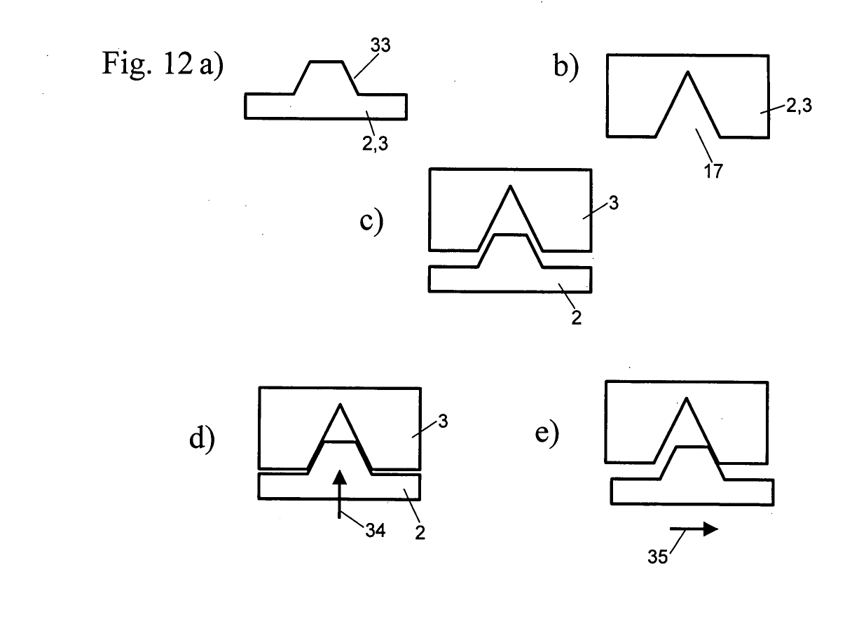

A further embodiment of the disclosure can be obtained by patterning inverted pyramids or ribs 33 and V-grooves 17 or pits as contacts. In this case, both wafer-parallel and wafer-normal contact displacement is possible. This embodiment is shown in FIG. 12, wherein it can be seen that the interlocking position (c) of the two contact elements 33 and 17 allows contact motion orthogonal along arrow 34 as well as contact motion parallel along arrow 35.

All the figures of the disclosure presented here show one degree of freedom: contact motion either normal or parallel to the wafer plane. It is implied that because of the three dimensional structure of the elements of the present disclosure two-degree-of-freedom and three-degree-of-freedom arrangements can be made, i.e. two degrees of freedom normal to the wafer plane, etc. Such multi-degree-of-freedom arrangements are to be understood as part of the present disclosure.

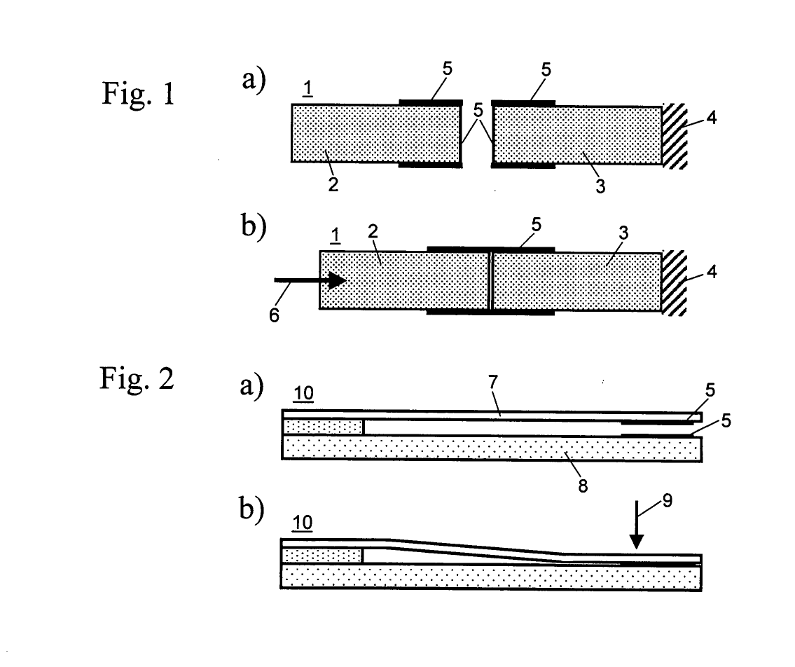

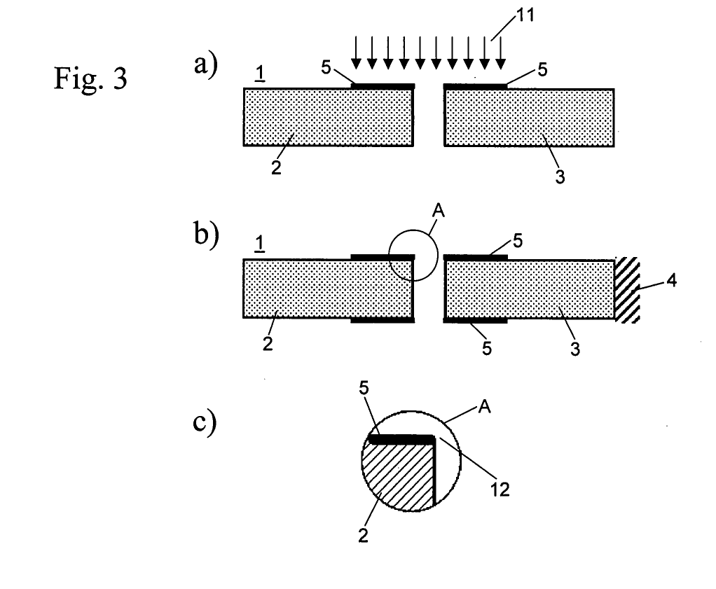

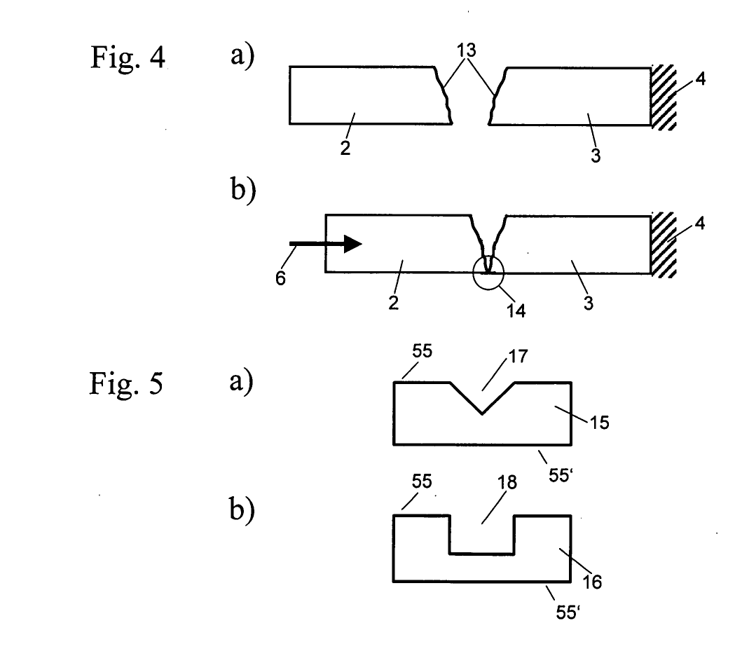

Highly planar and parallel side walls normal to the wafer surface can be obtained through wet anisotropic etching of (110) silicon as shown in FIG. 5. These sidewalls can be used as contacts in bulk micromachined MEMS relays and switches with contact movement parallel to the wafer plane as the one shown in FIG. 1. Although these contacts do not have as good a step coverage as the oblique contacts etched in (100) silicon they do offer the benefit of increased contact area when compared to dry etched trenches due to flatness and parallelism of the contact faces.

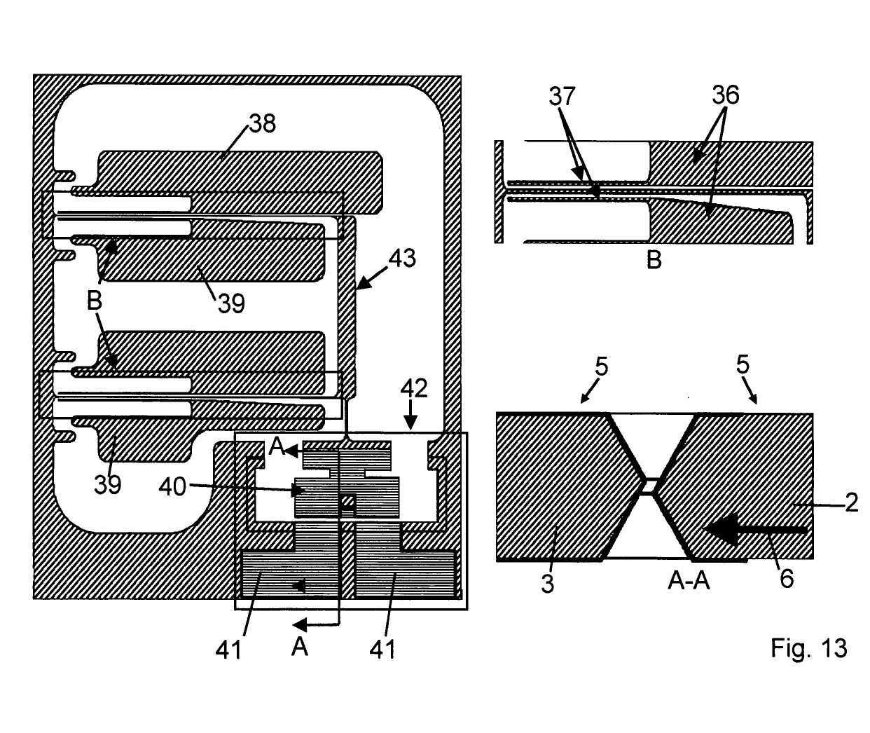

FIG. 13 shows an example of a MEMS relay which uses the oblique contacts described in the present disclosure. The low-voltage or actuation part of the MEMS relay comprises a parallelogram flexure-type 43 compliant mechanism, a pair of engaging electrostatic actuator electrodes 39 and a pair of disengaging actuator electrodes 38. Both the engaging and the disengaging actuators are rolling contact electrostatic “Zipper” type actuators. They are comprised of compliant 37 and a stiff 36 sections (see detail B), the compliant portion of which is used to reduce the pull-in voltage of the actuator by creating an initial contact point between the electrodes which then travels or “rolls” over the whole length of the actuator as the voltage is increased, thus creating the “zipper” motion. The high-voltage part of the MEMS relay comprises a stationary pair of oblique contacts (see detail A-A) and a moving contact or “cross bar”. All high voltage contacts have a thin conductive metal coating (gold) and are electrically insulated from the low-voltage side of the actuator through a silicon oxide film.

There are many feasible fabrication processes for the various geometries of the present disclosure (FIG. 6 through FIG. 13). These fabrication processes are dependent on the constraints imposed by additional MEMS components such as the mechanism and the actuator.

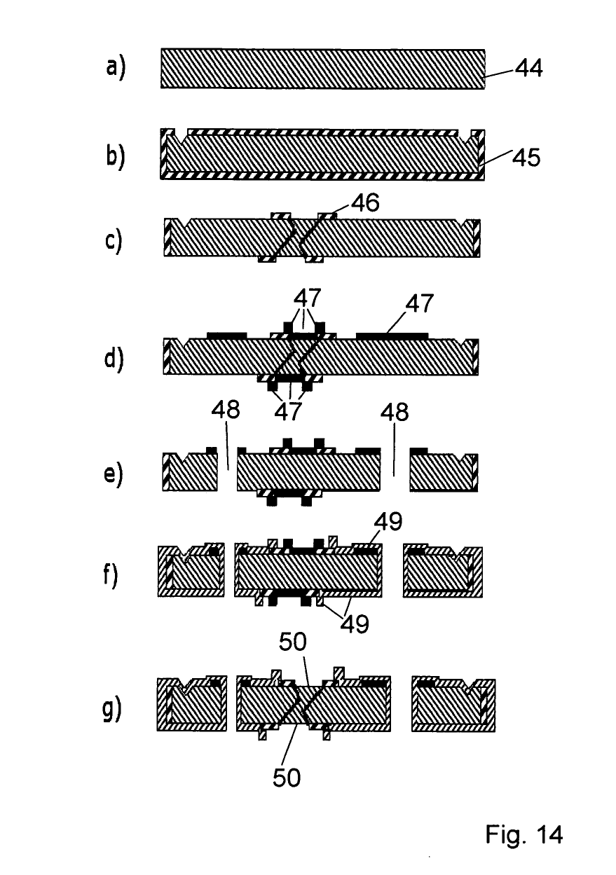

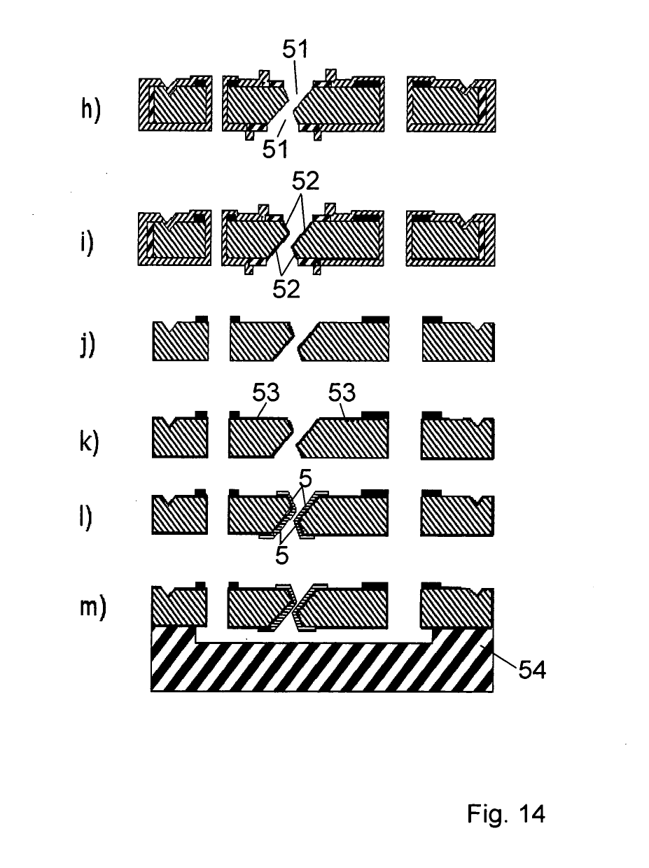

A fabrication process combining two wafer-through etches is particularly complex as photoresist cannot be spun onto wafers with deep features or onto wafers that have been through-etched. The compliant mechanism and the actuator of the MEMS relay shown in FIG. 13 are patterned with a dry etch while the oblique contacts are patterned with a wet anisotropic (KOH) etch. The process plan shown in FIG. 14 describes the use of “nested” masks to accurately pattern two subsequent wafer-through etches in the fabrication of the MEMS relay, e.g. as shown in FIG. 13. The “nested” silicon nitride mask for the wet-anisotropic (KOH) etch step is patterned in step c) of FIG. 14. This mask is then covered with a sacrificial layer of oxide (step d) and encapsulated in silicon nitride (step f) after performing the dry etch (step e). The “nested mask” is then uncovered by patterning the encapsulating nitride using a roughly aligned shadow-wafer mask and selectively etching the sacrificial silicon oxide (step g). Next, the wafer is etched in (KOH) to create the oblique contacts (step h). A protective thermal oxide is grown (step i) on the contact surfaces and the silicon nitride is selectively striped (step j). An insulating thermal oxide layer is grown (step k) over the wafer and patterned to gain access to the actuator. The contacts are metallized on both sides of the wafer using a shadow mask (step l) and the device wafer is bonded to a Pyrex™ handle wafer (step m).

The individual process steps are detailed below:
a) 300 μM, DSP silicon, 0.01 Ohm-cm
b) Deposit & pattern Si nitride 1 (KOH etch 1, define crystalline alignment of wafer)
c) Pattern Si nitride 1 (nested KOH mask)
d) Deposit & pattern oxide 1
e) DRIE (deep reactive ion etching), through etch
f) Deposit & pattern Si Nitride 2
g) Wet etch sacrificial oxide 1
h) KOH etch 2
i) Grow oxide 2 to protect (111) planes
j) Strip Si nitride
k) Grow insulation oxide
l) Metallization of contacts
m) Bonding to handle wafer (anodic bonding)

In even more detail the individual steps of FIG. 14 in a production protocol are given as follows:

| OP 10 (FIG. 14 a) | VTR Nitride Deposition 2kA | |
|---|---|---|
| | Thermco Systems, Vertical Thermal Reactor | |
| | (VTR), Series 6000 | |
| | 250 sccm Dichlorosilane | |
| | 25 sccm Ammonia | |
| | 250 mTorr | |
| | 775 degrees C. | |
| | 30 A/min | |
| Op 20-28 | Photo KOH align (HMDS, 1 um OCG | |
| | 825, prebake 30 min | |
| | 90 C., expose, EV1 2.3, develop OCG 934 1:1) | |
| OP 30 | Pattern Nitride 2kA KOH align mask | |
| | LAM490B, LAM Research Corporation | |
| | Pressure (mT) | 300 |
| | RF Power (W) | 130 |
| | Gap (cm) | 1.25 |
| | Oxygen (sccm) | 19 |
| | SF6 (sccm) | 190 |
| | time | 2 min 13 s (end |
| | | point settings not used) |

| | |
|---|---|
| OP 35 | Piranha (3:1 H2SO4 H2O2) 10 minutes, Photo |
| | Resist strip |
| Op 40 (FIG. 14 b) | KOH hood, 20% per weight @ 85 C. setpoint, Etch |
| | rate ~1.05 um/m |
| | KOH pellets 88.1% (WWR or J. T. Baker) CAS |
| | 1310-58-3 |
| OP 45 | 2X piranha + 50:1 HF dip, Post KOH clean; |
| | Piranha (3:1 H2SO4 H2O2), 10 minutes, HF dip |
| | 50:1 15 s |
| Op 50-57 | Photo nitride 1 top (HMDS, 1um OCG 825, prebake |
| | 30 min 90 C., expose EV1 2.3 s, Develop OCG 934 |
| | 1:1 t ~1 min, Postbake 30 min T = 130 C.) |
| Op 60 | Pattern Nitride top, LAM490B; idem step 30, end |
| | point settings t ~2 min 13 s |
| Op 62 | Piranha PR strip (idem step Op 35) |
| Op 70-77 | Photo nitride 1 bot (HMDS, 1um OCG 825, prebake |
| | 30 min 90 C., expose EV1 2.3 s, Develop OCG 934 |
| | 1:1 t ~1 min, Postbake 30 min T = 130 C.) |
| Op 80 (FIG. 14 c) | Pattern Nitride bot, LAM490B; idem step 30, end |
| | point settings t ~2 min 13 s |
| Op 82 | Piranha PR strip (idem step 35) |
| Op 90 | DCVD 5000A Silicon dioxide deposition, both |
| | wafer sides |
| Op 96 | Applied Materials Centura 5300 DCVD |
| | Anneal, tube B3. |
| | 1 h @ 950 C., 50% N2 flow |
| Op 100-109 | Photo oxide front and back(HMDS, 1um OCG 825, |
| | prebake 30 min 90 C., expose EV1 2.3 s, develop |
| | OCG 934 1:1 ~1 min, postbake 30 min 130 C.) |
| Op 110 (FIG. 14 d) | Pattern oxide |
| | BOE 7:1 6 min |
| Op 112 | Piranha PR strip (idem step 35) |
| Op 120-129 | Photo DRIE (HMDS, 8um AZ9260, prebake 60 min |
| | 90 C., expose EV1 4 × 5 s, develop AZ 440 MIF, |
| | postbake 30 min 90 C.) |
| Op 130 | Mount on handle wafer, prebake 15 min 90 C. |
| Op 140 (FIG. 14 e) | DRIE STS JBETCH recipe ~4 h, 28 mTorr |
| Op 144 | Piranha (IDEM 35) |
| Op 150 | VTR Nitride Deposition 2kA |
| | Thermco Systems, Vertical Thermal Reactor |
| | (VTR), Series 6000 |
| | 250 sccm Dichlorosilane |
| | 25 sccm Ammonia |
| | 250 mTorr |
| | 775 degrees C. |
| | 30 A/min |
| OP 160 | EV620, align shadow wafer front |
| OP 170 | Pattern Nitride front with shadow wafer. STS-2 |
| | 1 min teflon deposition (“polymer” recipe) 15 min |
| | “nitride” etch. |
| | Surface technology System, ICP Deep Trench |
| | Etching System |
| OP 175 | Piranha (IDEM 35) |
| OP 180 | EV620, align shadow wafer back |
| OP 190 (FIG. 14 f) | Pattern Nitride front with shadow wafer. STS-2 |
| | 1 min teflon deposition (“polymer” recipie) 15 min |
| | “nitride” etch. |
| | Surface technology System, ICP Deep Trench |
| | Etching System |
| OP 195 | Piranha (IDEM 35) |
| Op 200 (FIG. 14 g) | Pattern oxide |
| | BOE 7:1 6 min |
| OP 205 | Piranha (IDEM 35) |
| OP 210 (FIG. 14 h) | KOH hood, 20% per weight @ 85 C. setpoint, Etch |
| | rate ~1.05 um/m, t ~2 h KOH pellets 88.1% (WWR |
| | or J. T. Baker) CAS 1310-58-3 |
| OP 212 | 2X piranha + 50:1 HF dip, Post KOH clean; |
| | Piranha (3:1 H2SO4 H2O2) 10 minutes, HF dip |
| | 50:1 15 s |
| OP 220 | RCA station (10 min SC1, 15 s 50:1 HF dip, 15 min |
| | SC2), SC1 = 5:1:1 DI Water:H2O2:NH4OH |
| | HF DIP = 50:1 DI Water:HF, SC2 = 6:1:1 DI |
| | WATER:H2O2:HCL |
| OP 222 (FIG. 14 i) | Dry Thermal oxide growth (300A SIO2, 950 C. 1 h, |
| | 50% N2) |
| OP 230 (FIG. 14 j) | Hot phosphoric acid nitride stripping |
| OP 240 | RCA station (10 min SC1, 15 s 50:1 HF dip, 15 min |
| | SC2), SC1 = 5:1:1 DI Water:H2O2:NH4OH, HF |
| | DIP = 50:1 DI Water:HF, SC2 = 6:1:1 DI |
| | WATER:H2O2:HCL |
| OP 242 (FIG. 14 k) | Tube A-2, 2kA oxide growth |
| OP 250 | EV-620, shadow wafer alignment mask |
| OP 260 | Mount on handle |
| OP 270 | Oxide patterning STS-2 (idem 190, “jbetch” |
| | recipe) |
| op 280 | ev620 shadow wafer alignment metal top |
| op 282 | ev620 shadow wafer alignment metal bottom |
| OP 290 | e-beam Au deposit 1kA Ti, 7kA Au wafer front |
| OP 292 (FIG. 14 l) | e-beam Au deposit 1kA Ti, 7kA Au wafer back |
| OP 294 | piranha (idem 35) |
| OP 300 | RCA Au (idem 220) |
| OP 310 | EV620 Aligner/bonder (align and contact) |
| OP 320 (FIG. 14 m) | EV501 anodic bond |

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 switch/relay, bulk micro-machined
2 moving contact
3 static contact
4 support structure
5 conductive film/coating
6 direction of motion
7 moving contact
8 static contact
9 direction of motion
10 switch/relay, surface micro-machined
11 metallization
12 poor step coverage
13 tapering and non-planar contact surfaces
14 poor contact area
15 (100) silicon
16 (110) silicon
17 V-groove
18 trench
19a large oblique contact surface
19b small oblique contact surface
20 conductive film/coating on 19
21 contact area
22 first contact element in multiple-state switch
23 second contact element in multiple-state switch, contact cantilever
24 third contact element in multiple-state switch
25 direction of motion of 23 for contact between 23 and 24
26 direction of motion of 23 for contact between 22 and 23
27 multiple-state switch, in plane mobility of cantilever
28 multiple-state switch, out of plane mobility of cantilever
29 silicon wafer layer of the cantilever
30 thinned central wafer
31 large distance to 22
32 small distance to 24
33 truncated pyramid contact
34 out of plane motion of pyramid contact
35 in plane motion of pyramid contact
36 stiff section
37 compliant section
38 disengaging electrode
39 engaging electrode
40 contact crossbar (moving contact)
41 Gold contact
42 high voltage side
43 parallelogram flexure
44 raw wafer
45 Si nitride layer 1
46 patterned 45
47 patterned oxide layer 1
48 through etching by DRIE
49 deposit and patterned Si nitride layer 2
50 areas in which the oxide layer 1 is removed
51 anisotropically etched oblique surfaces
52 protective oxide layer 2 on (111) planes 51
53 insulation oxide layer
54 support wafer

What is claimed is:

1. Micro-electromechanical contact configuration comprising a static contact with at least one contact surface and a movable contact with at least one corresponding contact surface, wherein at least one contact surface plane is formed by a crystal plane of the wafer, wherein this crystal plane of the wafer is used as one of the contact surfaces.

2. Contact configuration according to claim 1, wherein both contacts are formed from an identical wafer crystal orientation, and wherein corresponding contact surfaces are formed by the same crystal plane of the wafers.

3. Contact configuration according to claim 2, wherein both contacts are formed from the same wafer.

4. Contact configuration according to claim 1, wherein the wafer has an upper surface and an undersurface which are parallel to each other, and wherein the contact surfaces are inclined with respect to said surfaces.

5. Contact configuration according to claim 4, wherein the wafer is a silicon wafer and wherein the contact surfaces are given by planes along the crystal plane.

6. Contact configuration according to claim 4, wherein each contact is provided with a pair of contact surfaces which are tilted with respect to each other.

7. Contact configuration according to claim 6, wherein the two pairs of contact surfaces are obtainable or obtained by means of wet etching of a V-groove from the upper surface and a parallel V-groove from the undersurface, wherein the two V-grooves are laterally offset from each other, thereby leading to a long contact surface and to a short contact surface on each contact.

8. Contact configuration according to claim 6, wherein the two pairs of contact surfaces are given as the two flanks of a V-groove on one contact and are given as the two flanks of a corresponding V-rib, truncated V-rib, pyramid or truncated pyramid-structure on the other contact.

9. Contact configuration according to claim 1, wherein the wafer has an upper surface and undersurface which are parallel to each other, and wherein for establishing a contact between the contact surfaces the movable contact moves parallel to said surfaces or substantially orthogonal to said surfaces.

10. Contact configuration according to claim 1, wherein there is provided a multiple-switching-state switch with at least two opposing static contacts, each provided with a pair of contact surfaces which are inclined with respect to each other and each with respect to an upper surface and undersurface of the wafer, and wherein there is provided at least one movable contact located between said two opposing static contacts.

11. Contact configuration according to claim 10, wherein the pairs of contact surfaces provided on the at least two opposing static contacts are mirror symmetric with respect to a central plane orthogonal to the surface of the wafer and parallel to the edges formed by the contact surfaces, and wherein the pairs of contact surfaces on the movable contact are mirror symmetric with respect to a central plane orthogonal to the surface of the wafer and parallel to the edges formed by the contact surfaces.

12. Contact configuration according to claim 10, wherein all the contacts are formed from the same wafer and wherein the movable contact moves substantially parallel to the upper surface for either establishing a contact between the first static contact and the movable contact or establishing a contact between the second static contact and the movable contact.

13. Contact configuration according to claim 10, wherein there is provided as stack of at least two wafers with the same crystal orientation, and wherein the movable contact moves at least partially orthogonal to the upper surface for either establishing a contact between a first static contact and the movable contact or establishing a contact between the second static contact and the movable contact, and wherein at least one or all of the static contacts are formed from a different wafer as the one out of which the movable contact is made.

14. Contact configuration according to claim 13, wherein the movable contact is formed from a middle wafer which is located between an upper wafer out of which one static contact is formed, and a lower wafer out of which the other static contact is formed.

15. Contact configuration according to claim 14, wherein the middle wafer in the region not contributing to the movable contact is reduced in thickness compared to the movable contact.

16. Contact configuration according to claim 1, wherein the contact surfaces are coated with an electrically conductive coating or film.

17. Contact configuration according to claim 1, wherein the contacts are formed from at least one polished silicon wafer with a thickness in the range of 150 μm-1000 μm, preferentially of 200 μm-400 μm.

18. Method for manufacturing a contact configuration according to claim 1, wherein the contact surfaces are obtained by wet anisotropic etching of a silicon wafer, if need be preceded by appropriate masking to expose the to-be-edged regions only, if need be followed by coating with an electrically conductive layer.

19. Method according to claim 18, wherein as an anisotropic etchant an aqueous hydroxide solution of alkali metals, preferably selected from NaOH, KOH, LiOH or mixtures thereof, or tetramethylammonium hydroxide (TmAH) or ethylene-diamine-pyrokatechol (EDP) are used in a concentration and under conditions such that the slower edging crystal planes are exposed.

20. Method according to claim 18, wherein a silicon wafer is etched from both sides such that two opposite and parallel V-grooves are forming which are offset with respect to each other, wherein the process leads to through-etching separating e.g. a future static contact from a future movable contact.

21. Contact configuration according to claim 3, wherein the wafer has an upper surface and an undersurface which are parallel to each other, and wherein the contact surfaces are inclined with respect to said surfaces.

22. Contact configuration according to claim 5, wherein each contact is provided with a pair of contact surfaces which are tilted with respect to each other.

23. Contact configuration according to claim 8, wherein the wafer has an upper surface and undersurface which are parallel to each other, and wherein for establishing a contact between the contact surfaces the movable contact moves parallel to said surfaces or substantially orthogonal to said surfaces.

24. Contact configuration according to claim 1, wherein there is provided a multiple-switching-state switch with at least two opposing static contacts, and wherein there is provided at least one movable contact located between said two opposing static contacts, provided with two pairs of contact surfaces which two pairs are located opposite to each other and which contact surfaces are inclined with respect to each other and each with respect to an upper surface and an undersurface of the wafer.

25. Contact configuration according to claim 11, wherein all the contacts are formed from the same wafer and wherein the movable contact moves substantially parallel to the upper surface for either establishing a contact between the first static contact and the movable contact or establishing a contact between the second static contact and the movable contact.

26. Contact configuration according to claim 12, wherein there is provided as stack of three wafers with the same crystal orientation, and wherein the movable contact moves at least substantially orthogonal to the upper surface for either establishing a contact between a first static contact and the movable contact or establishing a contact between the second static contact and the movable contact, and wherein at least one or all of the static contacts are formed from a different wafer as the one out of which the movable contact is made.

27. Contact configuration according to claim 1, wherein the contact surfaces are coated with an electrically conductive coating or film based on at least one of Ag, Au and Cu.

28. Contact configuration according to claim 16, wherein the contacts are formed from at least one, double side polished silicon wafer with a thickness in the range of 200 μm-400 μm.

29. Method for manufacturing a contact configuration according to claim 17, wherein the contact surfaces are obtained by wet anisotropic etching of a silicon wafer, if need be preceded by appropriate masking to expose the to-be-edged regions only, if need be followed by coating with an electrically conductive metal layer.

30. Method according to claim 19, wherein a silicon wafer is etched from both sides such that two opposite and parallel V-grooves are forming which are offset with respect to each other, wherein the process leads to through-etching separating e.g. a future static contact from a future movable contact.
